(19) United States
(12) Patent Application Publication
(10) Pub. No.: US 2021/0141283 A1
(43) Pub. Date: May 13, 2021

(54) SYSTEM AND METHOD FOR GENERATING MID-INFRARED OPTICAL FREQUENCY COMB BASED ON LITHIUM NIOBATE MICROCAVITY

(71) Applicant: Xi'an Institute of Optics and Precision Mechanics of CAS, Xi'an (CN)

(72) Inventors: Leiran Wang, Xi'an (CN); Qibing Sun, Xi'an (CN); Wenfu Zhang, Xi'an (CN); Chao Zeng, Xi'an (CN); Weichen Fan, Xi'an (CN); Wei Zhao, Xi'an (CN)

(21) Appl. No.: 16/891,440

(22) Filed: Jun. 3, 2020

(30) Foreign Application Priority Data
Nov. 7, 2019 (CN) 201911082533.8

(51) Int. Cl. G02F 1/35; G02F 1/355

(52) U.S. Cl. CPC G02F 1/3536; G02F 1/3551; G02F 2203/48; G02F 2202/20; G02F 2203/11; G02F 1/3501

(57) ABSTRACT

A system for generating a mid-infrared optical frequency comb based on a lithium niobate microcavity includes pumping units, a beam combining unit, a nonlinear frequency conversion unit and a filtering unit. The pumping units are divided into two paths and are configured to provide two paths of pumping light. The beam combining unit is configured to perform beam combination on the two paths of pumping light The nonlinear frequency conversion unit is configured to receive the beam-combined pumping light and undergo a nonlinear four-wave mixing process to generate a broadband optical frequency comb at a mid-infrared waveband. The filtering unit is configured to filter the remaining pumping light and output a mid-infrared optical frequency comb.

### FIELD

The present disclosure relates to a system and method for generating a mid-infrared optical frequency comb and in particular to a system and method for generating a high repetition frequency adjustable broadband mid-infrared optical frequency comb based on a lithium niobate microcavity.

### BACKGROUND

It is well known that the application of mid-infrared waveband laser to aspects such as spectroscopy, remote sensing, medical treatment and communication is specifically important. Compared with near-infrared waveband laser, the mid-infrared waveband laser covers absorption peaks of many atoms and molecules and has exceptional advantages in the field of spectral measurement. There is no doubt that the mid-infrared light wave and spectral measurement is not only a key for solving many scientific problems, but also a key for driving the development of many fields related to national economy and people's livelihood.

The key that the mid-infrared light waves are widely applied lies in the generation of an ultrawide-band, superfine and multi-wavelength light source, however, the problems of low spectral fineness and narrow bandwidth are frequently faced. The birth of an optical frequency comb (OFC for short) brings hope to solve the problems brought by the generation of the ultrawide-band, superfine and multi-wavelength light source. The optical frequency comb is an optical frequency scale with determined comb tooth spacing and frequency, and the disclosure of the optical frequency comb has the meaning of landmark in the fields of laser technologies and measurement science in the 21st century, based on this, professor Hansch from German and professor Hall from America won the Nobel Prize in physics in 2005.

After nearly 20 years of development, a series of significant progresses have been made in the development of the mid-infrared optical frequency comb, the mid-infrared optical frequency comb is generally generated by a mode locking laser using the frequency stabilizing and phase locking method, however, the mid-infrared optical frequency comb is greatly restricted in an actual application due to limitations on the volume, weight, power consumption (SWaP) and cost of the mode locking laser.

In recent years, a photonic integration technology has rapidly developed and provided a new technical means for the development of an optical frequency comb technology, wherein a microcavity optical frequency comb has achieved a great breakthrough and brought about a new round of technological revolution of the optical frequency comb technology. The microcavity optical frequency comb is achieved by injecting continuous laser into a reasonably designed microcavity and generated with an ultrahigh repetition frequency by virtue of the efficient nonlinear optical effect and relatively small size of a resonant cavity, and thus, the performances such as the volume, power consumption and cost of an optical frequency comb system are greatly improved. An existing microcavity is generally based on a silicon-based material, however, the silicon-based material generates the problems such as relatively high linear loss and multiphoton absorption on a mid-infrared waveband, thereby greatly restricting the performances of bandwidth and conversion efficiency of the optical frequency comb and restricting the further development of a mid-infrared microcavity optical frequency comb.

### SUMMARY

The present disclosure aims at providing a system and method for generating a high repetition frequency adjustable mid-infrared optical frequency comb based on a lithium niobate microcavity to solve the problem such as spectral bandwidth and efficiency restraints existing in a microcavity optical frequency comb made of a silicon-based material, achieve a mid-infrared optical frequency comb with wide bandwidth, high conversion efficiency and ultrahigh repetition frequency and realize great research significance and application value.

The lithium niobate material is relatively low in linear loss and nonlinear loss at a mid-infrared waveband, has good linear and nonlinear characteristics and a very strong electro-optical effect and also simultaneously has a second-order nonlinear effect and a third-order nonlinear effect, and capable of meeting functions such as low loss, efficient frequency conversion and rapid modulation, so as to become an ideal platform for mid-infrared microcavity optical frequency comb generation and applications.

In order to solve the above-mentioned problems, based on the above-mentioned analysis, a technical solution of the present disclosure is to provide a system for generating a high repetition frequency adjustable broadband mid-infrared optical frequency comb based on a lithium niobate microcavity, and the system is characterized by including pumping units, a beam combining unit, a nonlinear frequency conversion unit and a filtering unit;

the above-mentioned pumping units are divided into two paths and are configured to provide two paths of pumping light;

the above-mentioned beam combining unit is configured to perform beam combination on the two paths of pumping light;

the above-mentioned nonlinear frequency conversion unit is configured to receive the beam-combined pumping light and undergo a nonlinear four-wave mixing process to generate a broadband optical frequency comb at a mid-infrared waveband; and

the above-mentioned filtering unit is configured to filter the remaining pumping light and output a mid-infrared optical frequency comb.

Further, each pumping unit path includes a narrow linewidth tunable continuous laser source, a power amplifier and a polarization controller; the above-mentioned narrow linewidth tunable continuous laser source is configured to emit continuous signal light, the above-mentioned power amplifier is configured to amplify the intensity of the signal light, and the above-mentioned polarization controller is configured to adjust the polarization direction of the signal light; and

further, in order to optimize the intensity of the signal light to make the intensity conform to the intensity condition of four-wave mixing, the above-mentioned pumping units further include attenuators configured to adjust the intensity of the signal light.

Further, the above-mentioned beam combining unit is a beam combiner; and

further, the above-mentioned nonlinear frequency conversion unit includes a lithium niobate microcavity configured to undergo the nonlinear four-wave mixing process and a temperature controller configured to control the temperature of the lithium niobate microcavity.

Further, the above-mentioned filtering unit is a filter.

The present disclosure further provides a method for generating a mid-infrared optical frequency comb based on the above-mentioned system, including the following steps:

step 1, adjusting two paths of pumping units to emit two paths of signal light to ensure that intensities and polarization of the two paths of signal light meet an intensity condition and phase matching condition for four-wave mixing;

step 2, performing beam combination on the two paths of signal light by a beam combining unit to serve as pumping light of the nonlinear frequency conversion unit;

step 3, performing the four-wave mixing effect on signal light emitted into the nonlinear frequency conversion unit by the nonlinear frequency conversion unit to generate a mid-infrared optical frequency comb; and

step 4, filtering the remaining pumping light and outputting the mid-infrared optical frequency comb by a filtering unit.

Further, the nonlinear frequency conversion unit is a lithium niobate microcavity.

Further, step 1 specifically includes:

step 1.1, adjusting two narrow linewidth tunable continuous laser sources to ensure that the wavelength interval of laser emitted by the two laser sources is an integral multiple of a free spectral range of the lithium niobate microcavity, and taking the two beams of laser as the signal light of the pumping units; and

step 1.2, adjusting intensities of the two paths of signal light by power amplifiers and attenuators to meet an intensity condition for four-wave mixing; and respectively adjusting polarization directions of the two paths of signal light by two paths of polarization controllers to meet the phase matching condition for four-wave mixing.

The present disclosure has the advantages that:

1. The mid-infrared optical frequency comb is generated by adopting a double-pump lithium niobate microcavity method, capacity restraints such as bandwidth, repetition frequency and efficiency in a traditional method are broken, and the mid-infrared optical frequency comb with low threshold, large bandwidth as well as ultrahigh and adjustable repetition frequency may be achieved.

2. In the present disclosure, the mid-infrared optical frequency comb with the spectral bandwidth greater than or equal to 1000 nm and the repetition frequency greater than or equal to 200 GHz is achieved and the repetition frequency is increased by about 2-3 orders of magnitude as compared with that in a traditional method.

3. The high repetition frequency adjustable mid-infrared optical frequency comb is achieved in the present disclosure, the repetition frequency may be adjusted by controlling the wavelength interval of the two paths of pumping light, and the highest repetition-frequency is greater than or equal to 1 THz.

4. The system provided by the present disclosure is low in threshold, the threshold is lower than or equal to 15 mW, so that the efficiency of a mid-infrared optical frequency comb system is effectively increased, and the power consumption of the system is reduced.

5. The system provided by the present disclosure is simple in structure, convenient, practical, low in SWaP (volume, weight and power consumption), easy to integrate and low in cost and has the characteristics such as large bandwidth, adjustable repetition frequency and high stability.

### BRIEF DESCRIPTION OF THE DRAWINGS

FIG. 1 is a schematic frame diagram of the present disclosure;

FIG. 2 is a schematic structural diagram of a device provided by the present disclosure;

FIG. 3A is a result diagram of a mid-infrared optical frequency comb under the repetition frequency of 203 GHz;

FIG. 3B is a result diagram of a mid-infrared optical frequency comb under the repetition frequency of 609 GHz; and

FIG. 3C is a result diagram of a mid-infrared optical frequency comb under the repetition frequency of 1.02 THz;

Numeral symbols: 1—narrow linewidth tunable continuous laser source, 2—power amplifier, 3—attenuator, 4—polarization controller, 5—beam combiner, 6—lithium niobate microcavity, 7—temperature controller, and 8—filter.

### DETAILED DESCRIPTION OF THE EMBODIMENTS

The present disclosure is further described below in combination with accompanying drawings and specific embodiments.

Referring to FIG. 1 and FIG. 2, the present embodiment provides a system for generating a mid-infrared optical frequency comb based on a lithium niobate microcavity, including pumping units configured to provide two paths of pumping light, a beam combining unit configured to perform beam combination on the two paths of pumping light, a nonlinear frequency conversion unit configured to undergo a four-wave mixing process and a filter unit configured to filter the remaining pumping light.

As shown in FIG. 2, the pumping units in the present embodiment are divided into two paths, each pumping unit path includes a narrow linewidth tunable continuous laser source 1, a power amplifier 2, an attenuator 3 and a polarization controller 4 connected in sequence. The beam combining unit is a beam combiner 5 and is configured to perform beam combination on the two paths of pumping light; and in other embodiments, other forms of beam combining devices may also be adopted if only beam combination may be realized. The nonlinear frequency conversion unit includes a lithium niobate microcavity 6 configured to undergo a four-wave mixing effect and a temperature controller 7 configured to adjust the temperature of the lithium niobate microcavity 6. The filtering unit is a filter 8 and is configured to filter the remaining pumping light to obtain a mid-infrared optical frequency comb; and in other embodiments, other forms of filtering devices may also be adopted if only filtration may be realized.

Specifically, the mid-infrared optical frequency comb may be generated by the following processes:

1], the two narrow linewidth tunable continuous laser sources 1 are adjusted to ensure that the wavelength interval of laser emitted by the two laser sources is an integral multiple of a free spectral range of the lithium niobate microcavity 6, and the two beams of laser are taken as signal light of the pumping units;

2], intensities of the two paths of signal light are adjusted by the power amplifiers 2 and the attenuators 3 to meet an intensity condition for four-wave mixing (thus, the spectral bandwidth of the output optical frequency comb is maximized); and polarization directions of the two paths of signal light are respectively adjusted by two paths of the polarization controllers 4 to meet the phase matching condition for four-wave mixing; and

3], the two paths of adjusted signal light are injected into the lithium niobate microcavity 6 with high nonlinearity and low flattened dispersion after passing through the beam combiner 5, the temperature of the lithium niobate microcavity 6 is adjusted by the temperature controller 7 to meet a resonance condition (the wavelength of injected light is matched with the resonant wavelength of the microcavity) of the microcavity and the phase matching condition for four-wave mixing, and the pumping light undergoes the four-wave mixing effect with high efficiency and low threshold and then passes through the filter 8 to obtain the mid-infrared optical frequency comb to be output.

The working principle of the present disclosure is that:

firstly, narrow linewidth tunable continuous laser serves as the pumping light of the nonlinear frequency conversion unit after being subjected to power amplification; and the power of the pumping light is adjusted by the attenuators 3 and the power amplifiers 2 to meet the intensity condition for four-wave mixing, the polarization direction of the pumping light is adjusted by the polarization controllers 4 to meet the phase matching condition for four-wave mixing, the pumping light is injected into the lithium niobate microcavity 6 with high nonlinearity and low flattened dispersion after passing through the beam combiner 5, the temperature of the lithium niobate microcavity 6 is precisely adjusted by the temperature controller 7 to meet the resonance condition of the microcavity and the phase matching condition for four-wave mixing, and the pumping light undergoes the four-wave mixing effect with high efficiency and low threshold and then passes through the filter 8 to obtain the mid-infrared optical frequency comb.

Referring to FIG. 3A, FIG. 3B and FIG. 3C, the mid-infrared optical frequency comb generation results are provided. The ultrahigh repetition frequency adjustable broadband mid-infrared optical frequency comb with the spectral bandwidth greater than or equal to 1000 nm and the highest repetition-frequency greater than or equal to 1 THz may be achieved by using a double-pump lithium niobate microcavity method. The pumping units are established by using a double-pumping method, the nonlinear frequency conversion unit is established based on the four-wave mixing effect with the high efficiency and the low threshold in the lithium niobate microcavity, and the ultrahigh repetition frequency adjustable broadband mid-infrared optical frequency comb is achieved by controlling parameters such as power, polarization and wavelength of the pumping light. Moreover, the volume, power consumption and the like of a traditional mid-infrared optical frequency comb system may be reduced by several orders of magnitude, and meanwhile, the repetition frequency of the mid-infrared optical frequency comb may reach hundreds of GHz and even THz and is far higher than that of an optical frequency comb generated by a traditional mode locking laser.

1. A system for generating a mid-infrared optical frequency comb based on a lithium niobate microcavity, comprising: pumping units, a beam combining unit, a nonlinear frequency conversion unit and a filtering unit;
the pumping units being divided into two paths and being configured to provide two paths of pumping light;
the beam combining unit being configured to perform beam combination on the two paths of pumping light;
the nonlinear frequency conversion unit being configured to receive the beam-combined pumping light and undergo a nonlinear four-wave mixing process to generate a broadband optical frequency comb at a mid-infrared waveband; and
the filtering unit being configured to filter the remaining pumping light and output a mid-infrared optical frequency comb.

2. The system for generating the mid-infrared optical frequency comb based on the lithium niobate microcavity according to claim 1, wherein each pump unit path comprises a narrow linewidth tunable continuous laser source (1), a power amplifier (2) and a polarization controller (4);
the narrow linewidth tunable continuous laser source (1) is configured to emit continuous signal light; the power amplifier (2) is configured to amplify the intensity of the signal light; and the polarization controller (4) is configured to adjust the polarization direction of the signal light.

3. The system for generating the mid-infrared optical frequency comb based on the lithium niobate microcavity according to claim 2, wherein each pump unit path further comprises an attenuator (3) configured to adjust the intensity of the signal light.

4. The system for generating the mid-infrared optical frequency comb based on the lithium niobate microcavity according to claim 3, wherein the beam combining unit is a beam combiner (5).

5. The system for generating the mid-infrared optical frequency comb based on the lithium niobate microcavity according to claim 1, wherein the nonlinear frequency conversion unit comprises a lithium niobate microcavity (6) and a temperature controller (7) configured to control the temperature of the lithium niobate microcavity (6).

6. The system for generating the mid-infrared optical frequency comb based on the lithium niobate microcavity according to claim 5, wherein the filtering unit is a filter (8).

7. A method for generating a mid-infrared optical frequency comb based on the system for generating the mid-infrared optical frequency comb based on the lithium niobate microcavity according to claim 1, comprising the following steps:
step 1, adjusting two paths of pumping units to emit two paths of signal light to ensure that intensities and phases of the two paths of signal light meet an intensity condition and a phase matching condition for four-wave mixing;
step 2, performing beam combination on the two paths of signal light by a beam combining unit to serve as pumping light of a nonlinear frequency conversion unit;
step 3, performing a four-wave mixing effect on an incident pumping light signal by the nonlinear frequency conversion unit to generate a mid-infrared optical frequency comb; and
step 4, filtering the remaining pumping light and outputting the mid-infrared optical frequency comb by a filtering unit.

8. The method for generating the mid-infrared optical frequency comb according to claim 7, wherein the incident pumping light signal is subjected to the four-wave mixing effect by virtue of a lithium niobate microcavity (6) in step 3.

9. The method for generating the mid-infrared optical frequency comb according to claim 8, wherein step 1 specifically comprises:
step 1.1, adjusting two narrow linewidth tunable continuous laser sources (1) to output two beams of laser, and taking the two beams of laser as the signal light of the pumping units; and
step 1.2, adjusting intensities of the two paths of signal light by power amplifiers (2) and attenuators (3) to meet an intensity condition for four-wave mixing; and respectively adjusting polarization directions of the two paths of signal light by two paths of polarization controllers (4) to meet a phase matching condition for four-wave mixing.

10. The system for generating the mid-infrared optical frequency comb based on the lithium niobate microcavity according to claim 2, wherein the nonlinear frequency conversion unit comprises a lithium niobate microcavity (6) and a temperature controller (7) configured to control the temperature of the lithium niobate microcavity (6).

11. The system for generating the mid-infrared optical frequency comb based on the lithium niobate microcavity according to claim 3, wherein the nonlinear frequency conversion unit comprises a lithium niobate microcavity (6) and a temperature controller (7) configured to control the temperature of the lithium niobate microcavity (6).

12. The system for generating the mid-infrared optical frequency comb based on the lithium niobate microcavity according to claim 4, wherein the nonlinear frequency conversion unit comprises a lithium niobate microcavity (6) and a temperature controller (7) configured to control the temperature of the lithium niobate microcavity (6).
